(19) United States
(12) Patent Application Publication
(10) Pub. No.: US 2008/0150896 A1
(43) Pub. Date: Jun. 26, 2008

(54) Optical mouse with selectable dual light source device and detection method for the same

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/641,796

(22) Filed: Dec. 20, 2006

(51) Int. Cl. G09G 5/08

(52) U.S. Cl. 345/166

(57) ABSTRACT

The present invention discloses a selectable light source device for a dual light source optical mouse and a detecting method for the device. The optical input device such as an optical mouse is assembled with a dual light source. One of the dual light sources is selected as an emitting light source due to its brightness. The first surface characteristic value and the second surface characteristic value received by the signal comparing unit are compared and then the result signal is transmitted to the on/off control unit for controlling the on/off the switch of the laser-emitting unit and the light-emitting unit to determine if the light source is the laser-emitting unit or the light-emitting unit.

### BACKGROUND OF THE INVENTION

1. Field of the Invention

The present invention relates to a selectable dual light source device and a detection method for the same, and more especially to an optical mouse with dual light sources therein, and a detecting method for the same.

2. Description of the Prior Art

A traditional optical mouse has only one light source which is used as a light source. A light-emitting module includes an invisible light-emitting module and a visible light-emitting module. The visible light includes infrared. The invisible light includes laser. As such, two kinds of optical mouse may be made by the two different light-emitting modules respectively.

Taiwan patent No. 586607 proposed a “Dual light source co-work device”. This patent discloses a dual light source set in an electronic device. The invention provides a dual light source device which reduces both the size and cost of the device. A circuit diagram of the device is shown in FIG. 1. The dual light source device includes a light source structure 100 and a coupling solvent (not shown). The light source structure 100 includes a print circuit board 104, a laser module 101, and a LED module 102. The print circuit board 104 is mounted with a first electronic connecting end 1015 and a second electronic connecting end 1025. The first electronic connecting end 1015 and the second electronic connecting end 1025 are mounted on the print circuit board 104 in different directions, that is to say, the first electronic connecting end 1015 and the second electronic connecting end 1025 are set on opposites sides of the print circuit board 104. The laser module 101 is connected with the first electronic connecting end 1015. The LED module 102 has a hold 103 which extends to connect with the second electronic connecting end 1025 of the print circuit board 104.

Because the light sources for the dual light source device are set on opposites sides, the transverse area of perpendicular of the emitting direction of the light source and the occupied by the print circuit board is reduced. Thus, the device may be used in many ways, such as to add a pen-shaped shell or a flashlight.

The on and off switches for the dual light source are controlled by a push-on switch 105. If only one push-on switch is provided, the dual light source may be turned on simultaneously. Alternatively, two push-on switches are provided to control the laser module 101 and the LED module 102 respectively.

However, push-on switches are expensive, and they have a high rate of malfunction after use for an extended period of time. Moreover, there is no design for a dual light source being used in an optical mouse.

### SUMMARY OF THE INVENTION

Hence, the inventors of the present invention believe that the shortcomings described above can be improved upon and suggest the present invention which is of a reasonable design and is an effective improvement based on extensive research and thought.

An optical mouse assembled with a dual light source is disclosed. The push-on switch of the prior art is replaced by a bright reflected light signal. One of the dual light sources is selected as an emitting light source due to bright reflected light signal.

An object of the present invention is to provide an selectable light source device for a dual light source optical mouse and a detecting method for the same. The dual light source acts as an input device for the optical mouse after the reflecting signal of the dual light source is compared by a comparing unit, an on/off control unit chooses one of the dual light sources as a light source based on the reflecting signal.

To achieve the above-mentioned object, the selectable light source device for a dual light source optical mouse of the present invention is disclosed. The device is set on a workface, and the operating method of the device is wireless. The selectable light source device for the dual light source optical mouse has a light-emitting unit emitting visible light to the workface. A laser-emitting unit emits a laser to the workface. A photosensor receives the visible light reflected by the workface, and converts the reflected light into a first digital signal. A laser sensor receives the laser reflected of the workface and converts the reflected light into a second digital signal. A signal comparing unit is connected electronically with the photosensor and the laser sensor to compare the first digital signal with the second digital signal. A processing unit is electronically connected with the signal comparing unit to receive the comparing result of the first digital signal and the second digital signal for outputting a comparing signal. A on/off control unit is connected electronically with the processing unit to control the on and off switches of the light-emitting unit and the laser-emitting unit in accordance with the comparing signal.

A detecting method for the selectable light source device for the dual light source optical mouse of the present invention is also disclosed. The selectable light source device for the dual light source optical mouse is set on a workface. The detecting method is as follows: a visible light emitted from the light-emitting unit and a laser emitted from the laser-emitting unit are transmitted to the workface; a waiting time is generated by a timing unit; the visible light and the laser reflected by the workface are simultaneously detected by the photosensor and the laser sensor respectively; the visible light detected by the photosensor is converted into a first surface characteristic value; the laser detected by the laser sensor is converted into a second surface characteristic value; judge the first surface characteristic value is greater than the second surface characteristic value, if the result of the judging is true, the on/off control unit transmits an off signal to the laser-emitting unit.

The reflecting signal is produced by the workface reflecting the light emitted by the dual light source set in the optical input device and outputs the reflecting signal to the signal comparing unit for comparing the brightness of the reflecting signal. A comparing signal produced by the comparing result of the signal comparing unit is output to the on/off control unit to control one of the dual light sources to act as a light emitting source. The cost of the push-on switch is low and the malfunction rate of the push-on switch is reduced when compared to the prior art.

To further understand features and technical contents of the present invention please refer to the following detailed description and drawings related to the present invention. However, the drawings are only to be used as references and explanations, not to limit the present invention.

### BRIEF DESCRIPTION OF THE DRAWINGS

FIG. 1 is a circuit diagram of a dual light source device of the prior art;

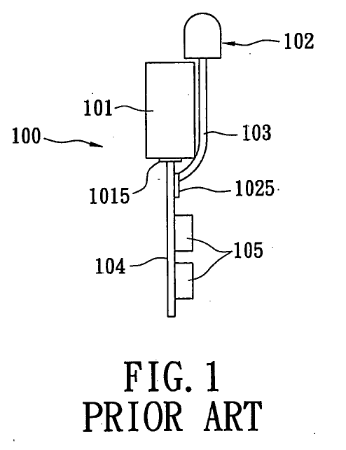

FIG. 2 is a block diagram of a selectable light source device for a dual light source optical mouse of the present invention; and

FIG. 3 is a flow chart of a detecting method of a selectable light source device for a dual light source optical mouse of the present invention.

### DETAILED DESCRIPTION OF THE INVENTION

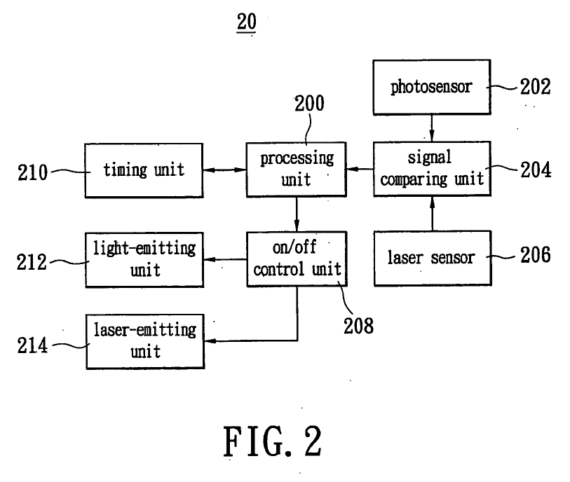

Referring to FIG. 2, a block diagram of a selectable light source device for a dual light source optical mouse of the present invention is shown. The selectable light source device 20 for the dual light source optical mouse is set on a workface and the operating method is wireless. The selectable light source device 20 includes at least one light-emitting unit 212 emitting visible light to the workface. The light-emitting unit 212 which emits visible light is a light-emitting diode (such as an infrared light-emitting diode) or an integrated circuit (IC) mounted with the light-emitting diode. A laser-emitting unit 214 emits a laser to the workface. The laser-emitting unit 214 may be an integrated circuit (IC) for emitting a laser. A photosensor 202 receives the visible light reflected by the workface, and then converts the reflected light into a first digital signal. A laser sensor 206 receives the laser reflected by the workface, and then converts the reflected light into a second digital signal. A signal comparing unit 204 is connected electronically with the photosensor 202 and the laser sensor 206 to compare the first digital signal and the second digital signal; the signal comparing unit 204 may be a comparing circuit. A processing unit 200 is connected electronically with the signal comparing unit 204 to receive the comparing result of the first digital signal and the second digital signal to output a comparing signal. The processing unit 200 may be a central processing unit, a microprocessor, or a digital processing unit. An on/off control unit 208 is connected electronically with the processing unit 200. The on/off switch of the light-emitting unit 212 and the laser-emitting unit 214 are controlled by the comparing signal. The on/off control unit 208 may be an electronic switch. A timing unit 210 is connected electronically with the processing unit 200 for providing timing function. The timing unit 210 may be a timer.

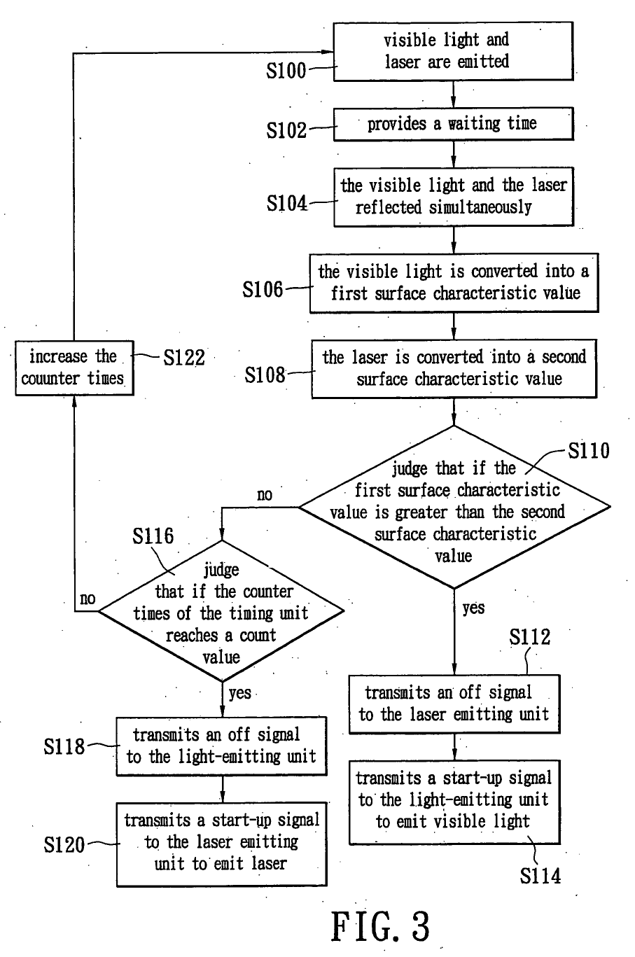

Refer to FIGS. 2 and 3. FIG. 3 is a flow chart of a detection method for a selectable light source device for a dual light source optical mouse of the present invention. The selectable light source device for the dual light source optical mouse is set on a workface and the steps are described as follows: a visible light and a laser are emitted to the workface from the light-emitting unit 212 and the laser-emitting unit 214 respectively (S100); the timing unit 210 generates a waiting time (S102), the waiting time may be 500 milliseconds. Next, the visible light and the laser reflected by the workface are simultaneously detected by the photosensor 202 and the laser sensor 206 (S104); the visible light detected by the photosensor 202 is converted into a first surface characteristics value (S106); the laser detected by the laser sensor 206 is converted into a second surface characteristic value (S108); the signal comparing unit 204 judges whether the first surface characteristic value is greater than the second surface characteristic value (S110); if the judging result is true, the on/off control unit 208 transmits an off signal to the laser-emitting unit 214 (S112) and transmits a start-up signal to the light-emitting unit 212 to emit a visible light (S114). Alternatively, if the result is false, further comprise judging whether the counter times of the timing unit 210 reach a count value is determined (S116). The count value may be defined three times. If the judging result is true in the S116, the on/off control unit 208 transmits an off signal to the light-emitting unit 212 (S118) and transmits a start-up signal to the laser-emitting unit 214 to emit a laser (S120). Alternatively, if the judging result is false in the S116, the counter times of the timing unit 210 are increased (S122).

To sum up, after comparing the first surface characteristic value and the second surface characteristic value received by the signal comparing unit 204, the signal comparing unit 204 will output the comparing signal to the on/off control unit 208 to control the on/off switch of the laser-emitting unit 214 and the light-emitting unit 212 to determine whether the light source is the laser-emitting unit 214 or the light-emitting unit 212. Thus, the problem caused by the push-on switch of the prior art can be overcome by the present invention. The method of the present invention lowers costs and reduces power consumption.

What is disclosed above is only the preferred embodiment of the present invention, and therefore it is intended that the present invention not be limited to the particular embodiment disclosed. It should be understood by those skilled in the art that various equivalent changes may be made depending on the specification and the drawings of present invention without departing from the scope of the present invention.

What is claimed is:

1. A selectable light source device for a dual light source optical mouse, the dual light source optical mouse is set on a workface, comprising:
a light-emitting unit for emitting a visible light to the workface,
a laser-emitting unit for emitting a laser to the workface,
a photosensor for receiving the visible light reflected by the workface, and then converting the visible light into a first digital signal,
a laser sensor for receiving the laser reflected by the workface, and then converting the laser into a second digital signal,
a signal comparing unit connecting electronically with the photosensor and the laser sensor to compare the first digital signal and the second digital signal,
a processing unit connecting electronically with the signal comparing unit to receive the comparing result of the first digital signal and the second digital signal, and then outputting a comparing signal, and
an on/off control unit connecting electronically with the processing unit, the on/off switch of the light-emitting unit and the laser-emitting unit are controlled by the comparing signal.

2. The selectable light source device for a dual light source optical mouse as claimed in claim 1, further comprising a timing unit connected electronically with the processing unit for providing timing function.

3. The selectable light source device for a dual light source optical mouse as claimed in claim 2, wherein the timing unit is a timer.

4. The selectable light source device for a dual light source optical mouse as claimed in claim 1, wherein the light-emitting unit which emits the visible light is a light-emitting diode or an integrated circuit mounted with the light-emitting diode.

5. The selectable light source device for a dual light source optical mouse as claimed in claim 1, wherein the laser-emitting unit is an integrated circuit for emitting a laser.

6. The selectable light source device for a dual light source optical mouse as claimed in claim 1, wherein the signal comparing unit is a comparing circuit.

7. The selectable light source device for a dual light source optical mouse as claimed in claim 1, wherein the processing unit is a central processing unit, a microprocessor, or a digital processing unit.

8. The selectable light source device for a dual light source optical mouse as claimed in claim 1, wherein the on/off control unit is an electronic switch.

9. A detection method for a selectable light source device for a dual light source optical mouse, the selectable light source device for the dual light source optical mouse is set on a workface, comprising:
emitting a visible light and a laser to the workface;
generating a waiting time;
detecting the visible light and the laser reflected by the workface simultaneously;
converting the visible light into a first surface characteristic value;
converting the laser into a second surface characteristic value;
judging whether the first surface characteristic value is greater than the second surface characteristic value, and
determining whether the source of the dual light source optical mouse is the visible light or the laser act as a light emitting source.

10. The detection method for a selectable light source device for a dual light source optical mouse as claimed in claim 9, wherein the step of the first surface characteristic value further comprises:
transmitting an off signal to the laser-emitting unit; and
transmitting a start-up signal to the light-emitting unit to emit visible light.

11. The detection method for a selectable light source device for a dual light source optical mouse as claimed in claim 9, wherein the step of judging whether the first surface characteristic value, if the judging result is false, further comprise judging whether the count times of the timing unit reaches a count value.

12. The detection method for a selectable light source device for a dual light source optical mouse as claimed in claim 11, wherein the step of judging whether the count times, if the judging result is true comprises:
transmitting an off signal to the light-emitting unit, and transmitting a start-up signal to the laser-emitting unit to emit laser light.

13. The detection method for a selectable light source device for a dual light source optical mouse as claimed in claim 11, wherein the step of judging whether the first surface characteristic value, if the judging result is false, comprises increasing the count of the timing unit.
